(19) United States
(12) Patent Application Publication
(10) Pub. No.: US 2024/0297421 A1
(43) Pub. Date: Sep. 5, 2024

(54) ELECTROCHEMICAL APPARATUS AND ELECTRONIC APPARATUS CONTAINING SAME

(71) Applicant: Ningde Amperex Technology Limited, Ningde (CN)

(72) Inventors: Shuxian YU, Ningde (CN); Bangsheng MING, Ningde (CN)

(73) Assignee: Ningde Amperex Technology Limited, Ningde (CN)

(21) Appl. No.: 18/660,768

(22) Filed: May 10, 2024

Related U.S. Application Data
(63) Continuation of application No. PCT/CN2021/130344, filed on Nov. 12, 2021.

(51) Int. Cl. H01M 50/538; H01M 10/0587; H01M 10/653

(52) U.S. Cl. CPC H01M 50/538; H01M 10/653; H01M 10/0587

(57) ABSTRACT

An electrochemical apparatus includes a first electrode plate, a separator, and a second electrode plate. The first electrode plate includes a first recess and a first tab with an end disposed in the first recess. The second electrode plate includes a first insulating layer disposed opposite the first tab of the first electrode plate, where the first insulating layer is directly disposed on a surface of a second current collector. In a thickness direction of the electrode assembly, an area of a projection of the first recess is smaller than an area of a projection of the first insulating layer, and the projection of the first recess is located within the projection of the first insulating layer.

### CROSS REFERENCE TO THE RELATED APPLICATIONS

This application is a continuation under 35 U.S.C. § 120 of international patent application PCT/CN2021/130344 filed on Nov. 12, 2021, the entire contents of which are incorporated herein by reference.

### TECHNICAL FIELD

This application relates to an electrochemical apparatus and an electronic apparatus containing the same.

### BACKGROUND

During charging of lithium-ion batteries, Li⁺ deintercalates from the positive electrode and intercalates into the negative electrode. However, in a case of some abnormal conditions (for example, insufficient space for lithium intercalation in the negative electrode, excessive resistance for Li⁺ intercalation into the negative electrode, or excessively rapid deintercalation of Li+ from the positive electrode but inability of intercalation into the negative electrode in the same amount), Li⁺ that cannot intercalate into the negative electrode can obtain electrons only on a surface of the negative electrode. Consequently, a silver-white metallic lithium element is formed and precipitates on the surface of the negative electrode. Such phenomenon is known as lithium precipitation.

Currently, batteries are mostly designed with a tab in the middle or with a multi-tab structure and therefore are prone to slot lithium precipitation.

### SUMMARY

In view of this, this application provides an electrochemical apparatus and an electronic apparatus containing the same, so as to solve the problem of slot lithium precipitation.

An embodiment of this application provides an electrochemical apparatus including an electrode assembly, where the electrode assembly includes a first electrode plate, a separator, and a second electrode plate. The first electrode plate includes a first current collector and a first active substance layer disposed on a surface of the first current collector, and the second electrode plate includes a second current collector and a second active substance layer disposed on a surface of the second current collector. The first electrode plate further includes a first recess, where the first recess is formed by absence of the first active substance layer. The first electrode plate further includes a first tab, where an end of the first tab is disposed in the first recess and is electrically connected to the first current collector. The second electrode plate includes a first insulating layer disposed opposite the first tab, where the first insulating layer is directly disposed on the surface of the second current collector. In a thickness direction of the electrode assembly, an area of a projection of the first recess is smaller than an area of a projection of the first insulating layer, and the projection of the first recess is located within the projection of the first insulating layer.

During charging, the electrochemical apparatus requires the following chemical reactions: positive electrode: LiCoO₂=Li^{1-X}CoO₂+x Li⁺+x e⁻; and negative electrode: 6C+x Li⁺+x e⁻=LiₓC₆. During charging, Li⁺ deintercalates from a positive electrode plate, passes through an electrolyte and the separator, and intercalates into an opposite negative electrode plate. In this application, the first electrode plate is the negative electrode plate, and the second electrode plate is the positive electrode plate. Since the first insulating layer is disposed on the surface of the second current collector (positive electrode current collector), the first insulating layer blocks electron conduction, so that LiCoO₂ cannot release e⁻ to the second current collector (positive electrode current collector), and the chemical reaction cannot take place. Therefore, the second electrode plate cannot release Li⁺ to intercalate into the opposite first electrode plate, decreasing the extractable positive electrode capacity of the second electrode plate, and thus effectively alleviating slot lithium precipitation.

In an embodiment, the second active substance layer includes a first active region disposed on the surface of the second current collector and a second active region disposed on a surface of the first insulating layer, where the second active region is provided with a first insulator on a surface facing away from the first insulating layer. Provision of the first insulator on the surface of the second active region of the second electrode plate is conducive to reducing the risk of short circuit between the first electrode plate and the second electrode plate caused by the first tab piercing the separator, and can also reduce the extractable capacity in the second active region, thereby reducing lithium precipitation.

In an embodiment, in the thickness direction of the electrode assembly, a total thickness of the first insulating layer and the second active region is equal to a thickness of the first active region. The first insulating layer is provided on the second current collector first, and then the first active region is provided on the surface, with no first insulating layer, of the second current collector while the second active region is provided on the first insulating layer at the same time. Since the provision method is extrusion coating, thicknesses of the regions of the second electrode plate are consistent with each other as a whole, so the total thickness of the first insulating layer and the thickness of the second active region on the surface of the first insulating layer is equal to the thickness of the adjacent first active region. In this way, although the first insulating layer is added, the thickness of the second electrode plate is not increased, bringing negligible effect on energy density of the electrochemical apparatus.

In an embodiment, in the thickness direction of the electrode assembly, the thickness of the first insulating layer is 5 μm-20 μm. The thickness of the first insulating layer falling within the range of 5 μm-20 μm not only guarantees an insulation effect but also reduces the influence on the energy density of the electrochemical apparatus.

In an embodiment, in the thickness direction of the electrode assembly, a thickness of the first insulating layer is equal to a thickness of the second active substance layer. A direction of the first tab extending out of the first electrode plate is defined as a first direction, and a direction perpendicular to both the first direction and the thickness direction of the electrode assembly is defined as a second direction. In the second direction, the first insulating layer is connected to the second active substance layer. In this embodiment, since the surface of the first insulating layer is provided with no second active substance layer, the second electrode plate has no extractable positive electrode capacity at a position of the first insulating layer, and the first insulator can be omitted, conducive to increasing the energy density of the electrochemical apparatus.

In an embodiment, the first recess exposes a portion of the surface of the first current collector. The exposed portion of the first current collector facilitates heat dissipation for the electrochemical apparatus during charging and discharging at a high rate; furthermore, at a position of the first recess where the first current collector is exposed, the first tab is connected to the first current collector, improving reliability of electrical connection of the first tab.

In an embodiment, the second electrode plate further includes a second recess, where the second recess is formed by absence of the second active substance layer. The second electrode plate further includes a second tab, where an end of the second tab is disposed in the second recess and electrically connected to the second current collector. A direction of the second tab extending out of the second electrode plate is defined as a first direction, and a direction perpendicular to both the first direction and the thickness direction of the electrode assembly is defined as a second direction. In the second direction, the second electrode plate is provided with a second insulating layer on two sides of the second recess, where the second insulating layer is directly disposed on the surface of the second current collector, and the second insulating layer is connected to the second active substance layer in the second direction. The second insulating layer is disposed on the surface of the second current collector near the second tab, and the second insulating layer blocks electron conduction, so that LiCoO₂ cannot release e⁻ to the second current collector, and the chemical reaction cannot take place. Therefore, the second electrode plate cannot release Li⁺ to intercalate into the opposite first electrode plate, thus effectively alleviating slot lithium precipitation.

In an embodiment, the second active substance layer includes a first active region disposed on the surface of the second current collector and a third active region disposed on a surface of the second insulating layer, where in the thickness direction of the electrode assembly, a total thickness of the second insulating layer and the third active region is equal to a thickness of the first active region. The second insulating layer is provided on the second current collector first, and then the first active region is provided on the surface, with no second insulating layer, of the second current collector while the third active region is provided on the second insulating layer at the same time. Since the provision method is extrusion coating, thicknesses of the regions of the second electrode plate are consistent with each other as a whole, so the total thickness of the second insulating layer and the thickness of the third active region on the surface of the second insulating layer is equal to the thickness of the adjacent first active region. In this way, although the second insulating layer is added, the thickness of the second electrode plate is not increased, bringing negligible effect on the energy density of the electrochemical apparatus.

In an embodiment, the thickness of the second insulating layer is 5 μm-20 μm. In this way, not only the insulation effect is guaranteed but also the influence on the energy density of the electrochemical apparatus is reduced.

In an embodiment, in the thickness direction of the electrode assembly, a thickness of the second insulating layer is equal to a thickness of the second active substance layer.

In an embodiment, the second electrode plate further includes a third insulator disposed on a surface of the second tab, where in the thickness direction of the electrode assembly, a projection of the third insulator at least partially overlaps with a projection of the second insulating layer. The third insulator is conducive to reducing the risk of short circuit between the first electrode plate and the second electrode plate caused by the second tab piercing the separator, and can also reduce the extractable capacity in the second active substance layer, thereby alleviating lithium precipitation.

In an embodiment, the first electrode plate further includes a fourth insulator disposed opposite the second tab, where the fourth insulator is disposed on a surface of the first active substance layer facing away from the first current collector. The fourth insulator is conducive to reducing the risk of short circuit between the first electrode plate and the second electrode plate caused by the second tab piercing the separator. In the thickness direction of the electrode assembly, the projection of the second insulating layer and the projection of the third insulator cover a projection of the fourth insulator. In this way, lithium ions deintercalating from the second electrode plate are received by the corresponding first active substance layer on the first electrode plate, reducing lithium precipitation.

In an embodiment, the first insulating layer includes an insulating material, where the insulating material includes at least one of polytetrafluoroethylene, polyvinylidene fluoride, or non-metallic silicate.

In an embodiment, in the thickness direction of the electrode assembly, a functional coating is provided between the first insulating layer and the second active substance layer. According to an embodiment of this application, the functional coating may be a ceramic coating; and provision of the functional coating can block electron conduction between the current collector and the active substance layer.

This application further provides an electronic apparatus including a load and the foregoing electrochemical apparatus, where the electrochemical apparatus is configured to supply power to the load.

In this application, the first insulating layer is directly provided on the surface of the second current collector to block electron conduction of the second current collector, so that the active material (for example, including but not limited to LiCoO₂) of the second active substance layer cannot release e to the second current collector, and the chemical reaction cannot take place. Therefore, the second electrode plate cannot release Li⁺ to intercalate into the opposite first electrode plate, decreasing the extractable positive electrode capacity of the second electrode plate, and thus effectively alleviating slot lithium precipitation.

### BRIEF DESCRIPTION OF DRAWINGS

FIG. 1 is a schematic structural diagram of an electrochemical apparatus according to an embodiment of this application.

FIG. 2 is a schematic structural diagram of an electrode assembly according to an embodiment of this application.

FIG. 3 is an enlarged view of position A in FIG. 1.

FIG. 4 is a schematic structural diagram of a first electrode plate according to an embodiment of this application.

FIG. 5 is a schematic diagram of projections of a first recess and a first insulating layer on a first electrode plate according to an embodiment of this application.

FIG. 6 is a locally enlarged schematic view of a first tab according to an embodiment of this application.

FIG. 7 is a schematic structural diagram of a second electrode plate according to an embodiment of this application.

FIG. 8 is an enlarged view of position B in FIG. 1.

FIG. 9 is a locally enlarged schematic view of a second tab according to an embodiment of this application.

FIG. 10 is a locally enlarged schematic view of a first tab according to another embodiment of this application.

FIG. 11 is a schematic structural diagram of an electronic apparatus according to an embodiment of this application.

Reference signs of main components

| | |
|---|---|
| Electrochemical apparatus | 100 |
| Electronic apparatus | 1000 |
| Electrode assembly | 10 |
| Housing | 20 |
| First electrode plate | 11 |
| Second electrode plate | 12 |
| Separator | 13 |
| First current collector | 111 |
| First active substance layer | 112 |
| First recess | 113 |
| First tab | 114 |
| Second current collector | 121 |
| Second active substance layer | 122 |
| Second recess | 123 |
| Second tab | 124 |
| First insulating layer | 31 |
| Second insulating layer | 32 |
| First insulator | 41 |
| Second insulator | 42 |
| Third insulator | 43 |
| Fourth insulator | 44 |
| First active region | 1221 |
| Second active region | 1222 |
| Third active region | 1223 |
| Thickness direction | X |
| First direction | Y |
| Second direction | Z |

Some embodiments of this application will be further described with reference to the accompanying drawings in the following specific embodiments.

### DETAILED DESCRIPTION

Unless otherwise defined, all technical and scientific terms used herein shall have the same meanings as commonly understood by those skilled in the art to which some embodiments of this application pertain. The terms used herein are for description of specific embodiments only without any intention to limit some embodiments of this application.

It should be noted that all directional indications (such as up, down, left, right, front, and back) in some embodiments of this application are only used for explaining relative positional relationships, motion situations, and the like between components in a specified posture (as shown in the accompanying drawings). If such specified posture changes, the directional indications correspondingly change as well.

In addition, the description about “first”, “second”, and the like in this application is merely for the purpose of description, and shall not be understood as any indication or implication of relative importance or any implicit indication of the number of technical features indicated. Therefore, a feature defined by “first” or “second” can explicitly or implicitly include one or more such features. In the description of this application, unless otherwise specifically stated, “a plurality of” means at least two, for example two or three.

The following describes in detail some embodiments of this application with reference to the accompanying drawings. In absence of conflicts, the following embodiments and features in some embodiments may be combined.

To alleviate slot lithium precipitation, short and narrow adhesive paper is typically attached to a negative electrode plate, and long and wide adhesive paper is attached to an opposite positive electrode plate, such that an active substance layer of the negative electrode plate is larger than an active substance layer of the positive electrode plate in both length and width directions.

However, because of soaking in the electrolyte for a long term, the adhesive paper loses some adhesion. The adhesive paper that has lost adhesion cannot suppress deintercalation of Li⁺ from the positive electrode plate. As a result, a negative electrode active substance layer at an edge of the adhesive paper at the negative electrode bear both Li⁺ deintercalating from the directly opposite positive electrode plate and Li⁺ that the nearby adhesive paper cannot suppress. The negative electrode plate cannot accept excessive intercalating Li⁺, and lithium dendrites precipitate on a surface of the negative electrode plate, leading to increasing amount of lithium precipitation in a slot, cycling attenuation, and deteriorated swelling.

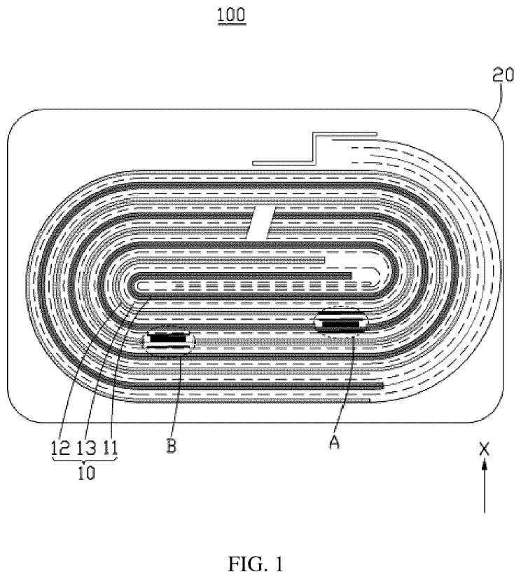

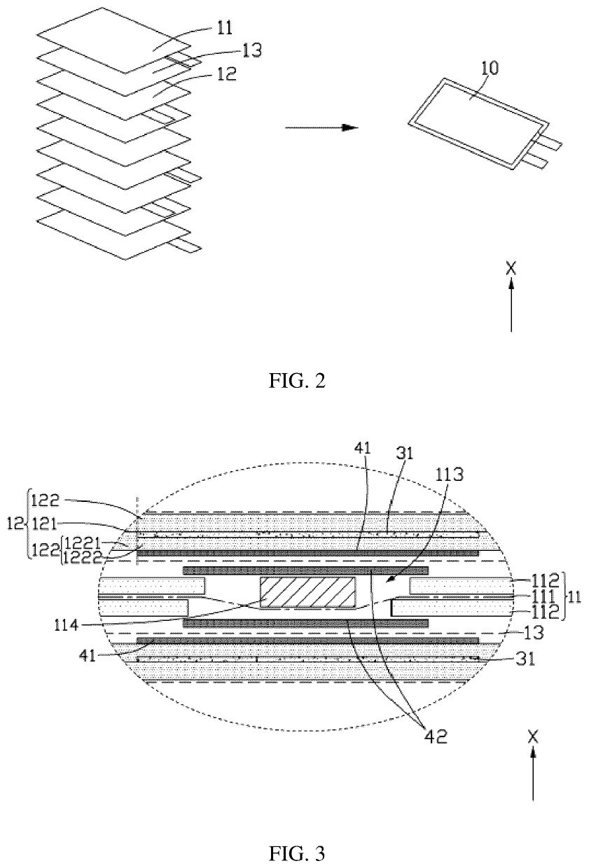

To alleviate slot lithium precipitation, an embodiment of this application provides an electrochemical apparatus 100. Refer to FIG. 1. The electrochemical apparatus 100 includes an electrode assembly 10, a housing 20 accommodating the electrode assembly 10, and an electrolyte (not shown in the figure). The electrode assembly 10 includes a first electrode plate 11, a second electrode plate 12, and a separator 13 disposed between the first electrode plate 11 and the second electrode plate 12. The separator 13 is configured to prevent direct contact between the first electrode plate 11 and the second electrode plate 12, but allows ions in the electrolyte to pass through. In FIG. 1, the electrode assembly 10 has a wound structure and is disposed inside the housing 20, to be specific, the first electrode plate 11, the separator 13, and the second electrode plate 12 are stacked sequentially and wound to form the electrode assembly 10. Certainly, the electrode assembly 10 may alternatively be formed by stacking the first electrode plate 11, the separator 13, and the second electrode plate 12 into a laminated structure as shown in FIG. 2. In this application, the first electrode plate 11 is a negative electrode plate, and the second electrode plate 12 is a positive electrode plate.

Refer to FIG. 3. The first electrode plate 11 includes a first current collector 111 and a first active substance layer 112 disposed on a surface of the first current collector 111. The first current collector 111 may be a negative electrode current collector commonly used in the art, and the negative electrode current collector may be made of a material such as metal foil or a porous metal plate, for example, made of metal such as copper, nickel, titanium, or iron, or alloy foil or porous plate thereof, such as copper foil. This is not limited in this application. The first active substance layer 112 includes a positive electrode active material, where the positive electrode active material may be any of various positive electrode active materials known in the art that can be used for electrochemical apparatuses. This is not limited in this application. For example, the positive electrode active material may include at least one of lithium cobaltate, lithium manganate, lithium iron phosphate, lithium manganese iron phosphate, nickel cobalt lithium manganate, lithium nickel cobalt aluminate, or lithium nickel manganate, and the positive electrode active material may undergo doping and/or coating processing. The first electrode plate 11 further includes a first recess 113, where the first recess 113 is formed by absence of the first active substance layer 112. Furthermore, in some embodiments, the first recess 113 may expose a portion of the first current collector 111. The exposed portion of the first current collector 111 facilitates heat dissipation for the electrochemical apparatus 100 during charging and discharging at a high rate. The first electrode plate 11 further includes a first tab 114, where an end of the first tab 114 is disposed in the first recess 113 and is electrically connected to the first current collector 111. At a position, of the first recess 113, where the first current collector 111 is exposed, the first tab 114 is connected to the first current collector 111, which can improve reliability of electrical connection of the first tab 114. The first tab 114 may be connected to the first current collector 111 through weld mark and/or conductive adhesive.

As shown in FIG. 3, the second electrode plate 12 includes a first insulating layer 31 disposed opposite the first tab 114, where the first insulating layer 31 is directly disposed on a surface of a second current collector 121. The “disposed opposite” means that the first insulating layer 31 is disposed on the surface of the second current collector 121 that is adjacent to the first tab 114 in a thickness direction X, and in the thickness direction X of the electrode assembly 10, a projection of the first insulating layer 31 (that is, an orthographic projection on a projection surface perpendicular to the thickness direction X of the electrode assembly 10) and a projection of the first tab 114 (that is, an orthographic projection on the projection surface perpendicular to the thickness direction X of the electrode assembly 10) at least partially overlap. It can be understood that the second current collector 121 in this application is a positive electrode current collector, and the second current collector 121 may use Al foil, or may use another positive electrode current collector commonly used in the art. The second current collector 121 may further include a substrate layer (for example, including but not limited to Al foil) and a primer layer (whose function includes but is not limited to increasing conductivity of the current collector) disposed on a surface of the substrate layer. In this application, that the first insulating layer 31 is directly disposed on a surface of a second current collector 121 means that when the second current collector 121 has only a substrate layer, the first insulating layer 31 is directly disposed on a surface of the substrate layer; and when the second current collector 121 includes a substrate layer and a primer layer, the first insulating layer 31 is directly disposed on a surface of the primer layer. No intermediate layer is present between the first insulating layer 31 and the second current collector 121.

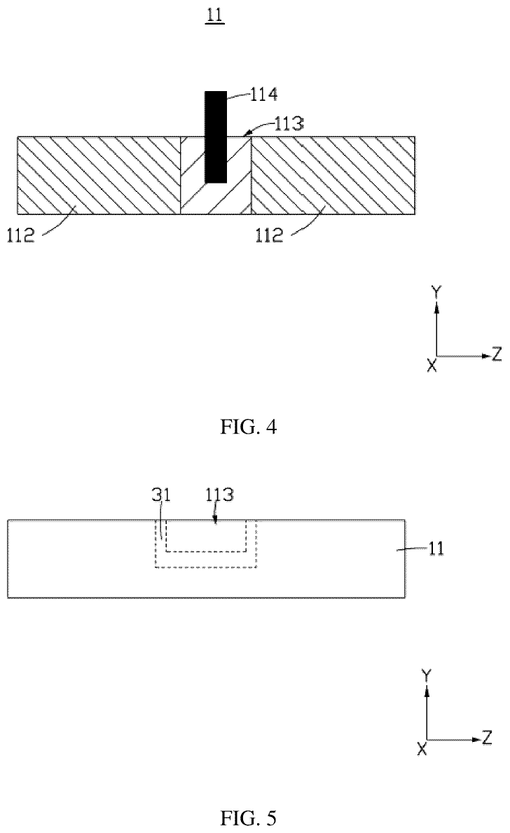

Refer to FIG. 4. A direction of the first tab 114 extending out of the first electrode plate 11 is defined as a first direction Y, and a direction perpendicular to both the first direction Y and the thickness direction X of the electrode assembly 10 is defined as a second direction Z. It can be understood that the first direction Y may be a length direction of the first electrode plate 11, and then the second direction Z is a width direction of the first electrode plate 11; or the first direction Y may be the width direction of the first electrode plate 11, and then the second direction Z is the length direction of the first electrode plate 11.

Refer to FIG. 5. In the thickness direction X of the electrode assembly 10, an area of a projection of the first recess 113 (that is, an orthographic projection on a projection surface perpendicular to the thickness direction X of the electrode assembly 10) is smaller than an area of the projection of the first insulating layer 31 (that is, the orthographic projection on the projection surface perpendicular to the thickness direction X of the electrode assembly 10), and the projection of the first recess 113 is located within the projection of the first insulating layer 31. In this way, it can be ensured that at a position of the first recess 113 where the first active substance layer 112 is absent, the corresponding second electrode plate 12 has no deintercalating Li⁺.

During charging, the electrochemical apparatus requires the following chemical reactions: positive electrode: LiCoO₂=Li^{1-X}CoO₂+x Li⁺+x e⁻; and negative electrode: 6C+x Li⁺+x e⁻=LiₓC₆. During charging, Li⁺ deintercalates from the positive electrode plate, passes through the electrolyte and the separator, and intercalates into the opposite negative electrode plate. In this application, since the first insulating layer is disposed on the surface of the second current collector (positive electrode current collector), the first insulating layer blocks electron conduction, so that LiCoO₂ cannot release e to the second current collector (positive electrode current collector), and the chemical reaction cannot take place. Therefore, the second electrode plate (positive electrode plate) cannot release Li⁺ to intercalate into the opposite first electrode plate (negative electrode plate), decreasing the extractable positive electrode capacity of the second electrode plate, and thus effectively alleviating slot lithium precipitation.

Furthermore, in an embodiment, the first recess 113 has a width of 9 μmm in the second direction Z and a length of 20 μmm in the first direction Y; and a second insulator 42 has a width of 9 μmm in the second direction Z and a length of 23 μmm in the first direction Y, where an area of a projection of the second insulator 42 in the thickness direction X is slightly larger than the area of the projection of the first recess 113 in the thickness direction X. In this case, the width of the first insulating layer 31 in the second direction Z may be 13 μmm to 18 μmm, then in the first direction, the length by which the first electrode plate 11 exceeds the second electrode plate 12 is 2 μmm to 4.5 μmm, with an excess of 2 μmm being preferable, which can ensure not only no lithium precipitation but also small capacity loss. Size of the first insulator 41 may be the same as size of the first insulating layer 31.

In some embodiments, the first insulating layer 31 includes an insulating material, where the insulating material includes at least one of polytetrafluoroethylene (teflon, PTFE), polyvinylidene fluoride (PVDF), or non-metallic silicate. Non-metallic silicate includes but is not limited to glass, ceramics, cement, plastics, fiber, or rubber. The first insulating layer 31 is stable at high temperature and high pressure and will not fail due to soaking in the electrolyte; the first insulating layer 31 is light and thin, conducive to increasing energy density; and the size of the first insulating layer 31 can be flexibly set depending on needs.

Refer to FIG. 3. The second electrode plate 12 includes a second current collector 121 and a second active substance layer 122 disposed on a surface of the second current collector 121. The second active substance layer 122 includes a negative electrode active material. The negative electrode active material may include at least one of a carbonaceous material, a silicon-carbon material, an alloy material, a lithium-containing metal composite oxide material, but is not limited thereto. The negative electrode active material may be a conventionally known material among the various materials known in the art that can be used as a negative electrode active material of electrochemical apparatuses and that can allow for electrochemical intercalation and deintercalation of active ions. In some embodiments, the second active substance layer 122 includes a first active region 1221 disposed on the surface of the second current collector 121 and a second active region 1222 disposed on a surface of the first insulating layer 31, where the second active region 1222 is provided with a first insulator 41 on a surface facing away from the first insulating layer 31. Provision of the first insulator 41 on the surface of the second active region 1222 of the second electrode plate 12 is conducive to reducing the risk of short circuit between the first electrode plate 11 and the second electrode plate 12 caused by the first tab 114 piercing the separator 13, and can also reduce the extractable capacity in the second active region, thereby reducing lithium precipitation. The first tab 114 is disposed in the first recess 113, and a surface of the first tab 114 generally needs to be attached to the second insulator 42 to reduce the risk of short circuit between the first electrode plate 11 and the second electrode plate 12 caused by the first tab 114 piercing the separator 13. The first insulator 41 and the second insulator 42 may be but are not limited to adhesive paper commonly used in the art.

In FIG. 3, in the thickness direction X of the electrode assembly 10, a total thickness of the first insulating layer 31 and the second active region 1222 is equal to a thickness of the first active region 1221. The first insulating layer 31 is provided on the second current collector 121 first, and then the first active region 1221 is provided on the surface, with no first insulating layer 31, of the second current collector 121 while the second active region 1222 is provided on the first insulating layer 31 at the same time. Since the provision method is extrusion coating, thicknesses of the regions of the second electrode plate 12 are consistent with each other as a whole, so the total thickness of the first insulating layer 31 and the thickness of the second active region 1222 on the surface of the first insulating layer 31 is equal to the thickness of the adjacent first active region 1221. In this way, although the first insulating layer 31 is added, the thickness of the second electrode plate 12 is not increased, bringing negligible effect on energy density of the electrochemical apparatus.

Furthermore, in some embodiments, in the thickness direction X of the electrode assembly 10, the thickness of the first insulating layer 31 may be 5 μm-20 μm. In these embodiments, the thickness of the second active substance layer 122 (the thickness of the first active region 1221) is approximately 50 μm, and the thickness of the first insulating layer 31 falling within the range of 5 μm-20 μm not only guarantees an insulation effect but also reduces the influence on the energy density of the electrochemical apparatus 100.

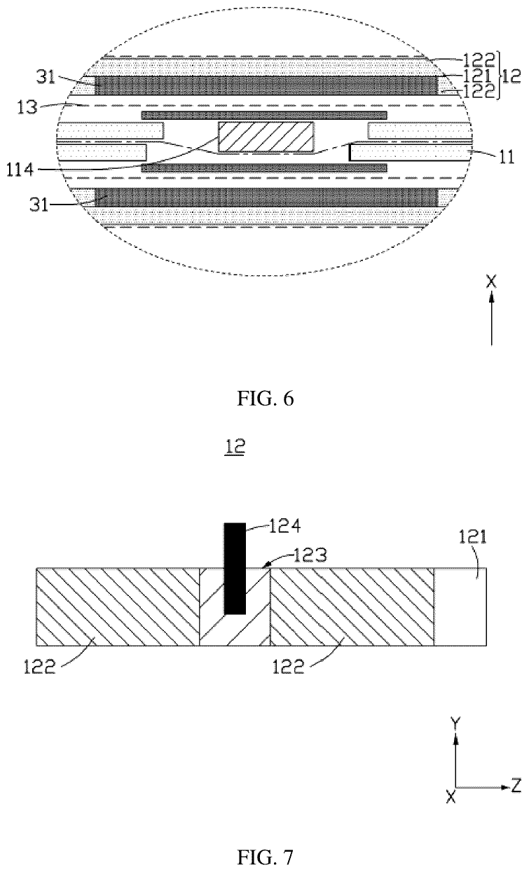

Refer to FIG. 6. In some other embodiments, in the thickness direction X of the electrode assembly 10, the thickness of the first insulating layer 31 may alternatively be equal to the thickness of the second active substance layer 122, and the first insulating layer 31 is connected to the second active substance layer in the second direction Z. In these embodiments, the thickness of the second active substance layer 122 is uniform, without distinction between the first active region 1221 and the second active region 1222. The surface of the first insulating layer 31 is provided with no second active substance layer 122, the second electrode plate 12 has no extractable positive electrode capacity at a position of the first insulating layer 31, and the first insulating layer 31 can also reduce the risk of short circuit caused by the first tab 114 piercing the separator 13, so the first insulator 41 shown in FIG. 3 can be omitted, conducive to increasing the energy density of the electrochemical apparatus 100.

In some embodiments, in the thickness direction X of the electrode assembly 10, a functional coating may be provided between the first insulating layer 31 and the second active substance layer 122. Furthermore, the functional coating may be a ceramic coating; and provision of the functional coating can block electron conduction between the current collector and the active substance layer.

Refer to FIG. 7. The second electrode plate 12 further includes a second recess 123, where the second recess 123 is formed by absence of the second active substance layer 122. The second electrode plate 12 further includes a second tab 124, where an end of the second tab 124 is disposed in the second recess 123 and electrically connected to the second current collector 121. Furthermore, in some embodiments, the second recess 123 may expose a portion of the surface of the second current collector 121. The exposed portion of the second current collector 121 facilitates heat dissipation for the electrochemical apparatus 100 during charging and discharging at a high rate. At a position, of the second recess 123, where the second current collector 121 is exposed, the second tab 124 is connected to the second current collector 121, which can improve reliability of electrical connection of the second tab 124. The second tab 124 may be connected to the second current collector 121 through weld mark and/or conductive adhesive.

In FIG. 7, a direction of the second tab 124 extending out of the second electrode plate 12 is defined as a first direction Y (consistent with the direction along which the first tab 114 extends out of the first electrode plate 11), and a direction perpendicular to both the first direction Y and the thickness direction X of the electrode assembly 10 is defined as a second direction Z.

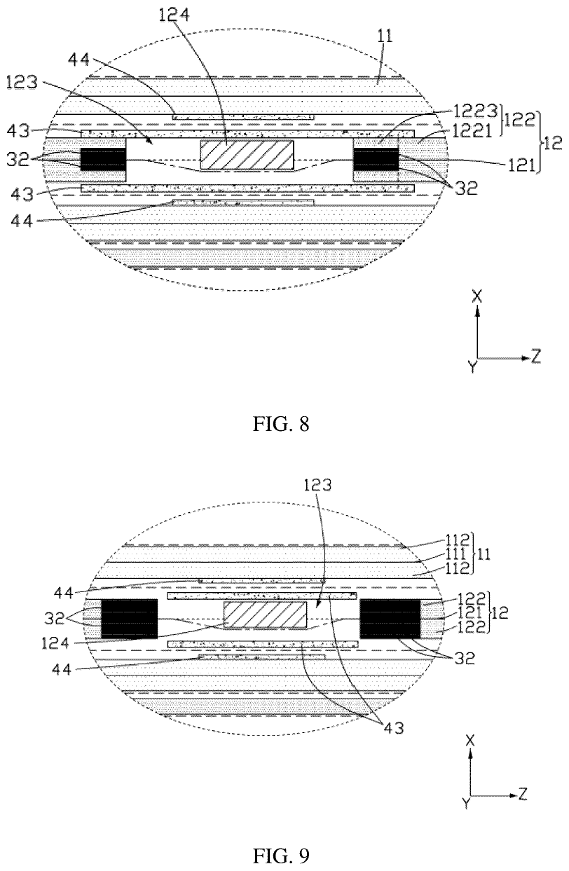

Refer to FIG. 8. In some embodiments, the second electrode plate 12 is provided with a second insulating layer 32 on two sides of the second recess 123 in the second direction Z, where the second insulating layer 32 is disposed on the surface of the second current collector 121 (no intermediate layer is present between the second insulating layer 32 and the second current collector 121), and the second insulating layer 32 is connected to the second active substance layer 122 in the second direction Z. The second insulating layer 32 is disposed on the surface of the second current collector 121 near the second tab 124, and the second insulating layer 32 blocks electron conduction, so that LiCoO₂ cannot release e⁻ to the second current collector 121, and the chemical reaction cannot take place. Therefore, the second electrode plate 12 cannot release Li⁺ to intercalate into the opposite first electrode plate 11, thus further alleviating slot lithium precipitation.

In some embodiments, the second insulating layer 32 includes an insulating material, where the insulating material includes at least one of polytetrafluoroethylene (teflon, PTFE), polyvinylidene fluoride (PVDF), or non-metallic silicate. Non-metallic silicate includes but is not limited to glass, ceramics, cement, plastics, fiber, or rubber. The second insulating layer 32 is stable at high temperature and high pressure and will not fail due to soaking in the electrolyte; the second insulating layer 32 is light and thin, conducive to increasing energy density; and the size of the second insulating layer 32 can be flexibly set depending on needs.

As shown in FIG. 8, in some embodiments, the second active substance layer 122 includes a first active region 1221 disposed on the surface of the second current collector 121 and a third active region 1223 disposed on a surface of the second insulating layer 32, where in the thickness direction X of the electrode assembly 10, a total thickness of the second insulating layer 32 and the third active region 1223 on the surface of the second insulating layer 32 is equal to a thickness of the first active region 1221. The second insulating layer 32 is provided on the second current collector 121 first, and then the first active region 1221 is provided on the surface, with no second insulating layer 32, of the second current collector 121 while the third active region 1223 is provided on the second insulating layer 32 at the same time. Since the provision method is extrusion coating, thicknesses of the regions of the second electrode plate 12 are consistent with each other as a whole, so the total thickness of the second insulating layer 32 and the thickness of the third active region 1223 on the surface of the second insulating layer 32 is equal to the thickness of the adjacent first active region 1221. In this way, although the second insulating layer 32 is added, the thickness of the second electrode plate 12 is not increased, bringing negligible effect on energy density of the electrochemical apparatus.

Furthermore, in some embodiments, the thickness of the second insulating layer is 5 μm-20 μm. In this way, not only the insulation effect is guaranteed but also no influence is imposed on the energy density of the electrochemical apparatus.

As shown in FIG. 8, in some embodiments, the second electrode plate 12 further includes a third insulator 43 disposed on a surface of the second tab 124, where in the thickness direction X of the electrode assembly 10, a projection of the third insulator 43 and a projection of the second insulating layer 32 at least partially overlap. The third insulator 43 is conducive to reducing the risk of short circuit between the first electrode plate 11 and the second electrode plate 12 caused by the second tab 124 piercing the separator 13, and can also reduce the extractable capacity in the second active substance layer 122, thereby alleviating lithium precipitation. The third insulator 43 may be but is not limited to adhesive paper commonly used in the art.

Still refer to FIG. 8. In some embodiments, the first electrode plate 11 further includes a fourth insulator 44 disposed opposite the second tab 124, where the fourth insulator 44 is disposed on a surface of the first active substance layer 112 facing away from the first current collector 111. The “disposed opposite” means that the fourth insulator 44 is disposed on the surface of the first electrode plate 11 that is adjacent to the second tab 124 in the thickness direction X, and in the thickness direction X of the electrode assembly 10, a projection of the fourth insulator 44 (that is, an orthographic projection on a projection surface perpendicular to the thickness direction X of the electrode assembly 10) and a projection of the second tab 124 (that is, an orthographic projection on the projection surface perpendicular to the thickness direction X of the electrode assembly 10) at least partially overlap. The fourth insulator 44 is conducive to reducing the risk of short circuit between the first electrode plate 11 and the second electrode plate 12 caused by the second tab 124 piercing the separator 13. In the thickness direction X of the electrode assembly 10, the projection of the second insulating layer 32 and the projection of the third insulator 43 cover the projection of the fourth insulator 44. In this way, lithium ions deintercalating from the second electrode plate 12 are received by the corresponding first active substance layer 112 on the first electrode plate 11, reducing lithium precipitation. The fourth insulator 44 may be but is not limited to adhesive paper commonly used in the art.

Refer to FIG. 9. In some other embodiments, in the thickness direction X of the electrode assembly 10, the thickness of the second insulating layer 32 may be equal to the thickness of the second active substance layer 122. In these embodiments, the thickness of the second active substance layer 122 is uniform, without distinction between the first active region 1221 and the third active region 1223. The surface of the second tab 124 may also be provided with the third insulator 43, and the first electrode plate 11 may also include the fourth insulator 44 disposed opposite the second tab 124, with the projection of the second insulating layer 32 and the projection of the third insulator 43 covering the projection of the fourth insulator 44.

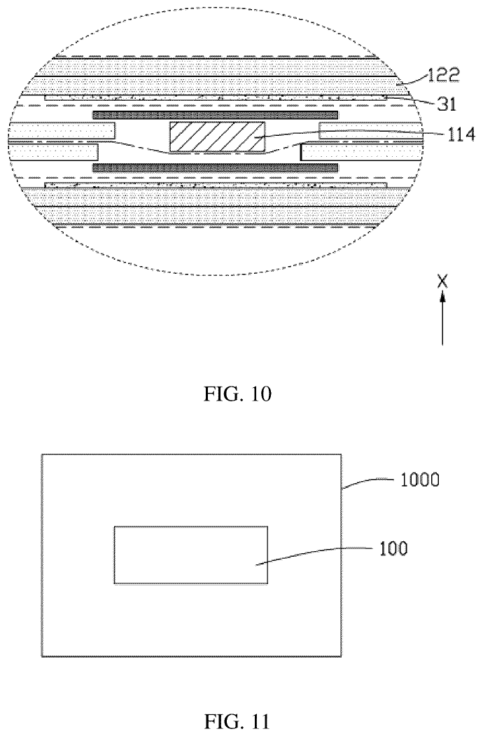

Refer to FIG. 10. In some embodiments, the first insulator 41 (as shown in FIG. 3), that is, adhesive paper, on the surface of the second active substance layer 122 can be replaced with the second insulating layer 32. Since the second insulating layer 32 has more stable performance compared with adhesive paper and will not fail due to soaking in the electrolyte, the provision as shown in FIG. 10 can also alleviate slot lithium precipitation.

Refer to FIG. 11. This application further provides an electronic apparatus 1000 including a load (not shown in the figure) and the foregoing electrochemical apparatus 100, where the electrochemical apparatus 100 is configured to supply power to the load. In some embodiments, the electronic apparatus 1000 in this application may be but is not limited to a mobile phone, a notebook computer, an electronic notepad, a calculator, a memory card, a radio, a standby power source, a motor, a lighting appliance, a toy, a game console, a clock, an electric tool, a flash lamp, a camera, a large household battery, or a lithium-ion capacitor.

In this application, the first insulating layer 31 is directly provided on the surface of the second current collector 121 to block electron conduction of the second current collector 121, so that the active material (for example, including but not limited to LiCoO₂) of the second active substance layer 122 cannot release e to the second current collector 121, and the chemical reaction cannot take place. Therefore, the second electrode plate 12 cannot release Li⁺ to intercalate into the opposite first electrode plate 11, decreasing the extractable positive electrode capacity of the second electrode plate 12, and thus effectively alleviating slot lithium precipitation.

The above descriptions are some specific embodiments of this application, but in an actual application process, this application should not be limited to these embodiments. For persons of ordinary skill in the art, all other modifications and changes according to the technical concept of this application shall fall within the protection scope of this application.

What is claimed is:

1. An electrochemical apparatus, comprising an electrode assembly, wherein the electrode assembly comprises a first electrode plate, a separator, and a second electrode plate; the first electrode plate comprises a first current collector and a first active substance layer disposed on a surface of the first current collector, and the second electrode plate comprises a second current collector and a second active substance layer disposed on a surface of the second current collector; wherein
the first electrode plate further comprises a first recess, wherein the first recess exposes a portion of the surface of the first current collector; the first electrode plate further comprises a first tab, wherein an end of the first tab is disposed in the first recess; the second electrode plate comprises a first insulating layer disposed opposite to the first tab, wherein the first insulating layer is directly disposed on the surface of the second current collector; and in a thickness direction of the electrode assembly, an area of a projection of the first recess is smaller than an area of a projection of the first insulating layer, and the projection of the first recess is located within the projection of the first insulating layer.

2. The electrochemical apparatus according to claim 1, wherein the second active substance layer comprises a first active region disposed on the surface of the second current collector and a second active region disposed on a surface of the first insulating layer, and the second active region is provided with a first insulator on a surface facing away from the first insulating layer.

3. The electrochemical apparatus according to claim 2, wherein in the thickness direction of the electrode assembly, a total thickness of the first insulating layer and the second active region is equal to a thickness of the first active region.

4. The electrochemical apparatus according to claim 3, wherein in the thickness direction of the electrode assembly, the thickness of the first insulating layer is 5 μm-20 μm.

5. The electrochemical apparatus according to claim 1, wherein in the thickness direction of the electrode assembly, a thickness of the first insulating layer is equal to a thickness of the second active substance layer; the first tab extends out of the first electrode plate in a first direction, and a direction perpendicular to both the first direction and the thickness direction of the electrode assembly is defined as a second direction; and in the second direction, the first insulating layer is connected to the second active substance layer.

6. The electrochemical apparatus according to claim 1, wherein the second electrode plate further comprises a second recess, the second recess exposes a portion of the surface of the second current collector, the second electrode plate further comprises a second tab, and an end of the second tab is disposed in the second recess; and the second tab extends out of the second electrode plate in a first direction, and a direction perpendicular to both the first direction and the thickness direction of the electrode assembly is defined as a second direction; wherein
in the second direction, the second electrode plate is provided with a second insulating layer on two sides of the second recess, the second insulating layer is disposed on the surface of the second current collector, and the second insulating layer is connected to the second active substance layer in the second direction.

7. The electrochemical apparatus according to claim 6, wherein in the thickness direction of the electrode assembly, a thickness of the second insulating layer is equal to a thickness of the second active substance layer.

8. The electrochemical apparatus according to claim 6, wherein the second active substance layer comprises a first active region disposed on the surface of the second current collector and a third active region disposed on a surface of the second insulating layer; and in the thickness direction of the electrode assembly, a total thickness of the second insulating layer and the third active region is equal to a thickness of the first active region.

9. The electrochemical apparatus according to claim 8, wherein the thickness of the second insulating layer is 5 μm-20 μm.

10. The electrochemical apparatus according to claim 6, wherein the second electrode plate further comprises a third insulator disposed on a surface of the second tab, and in the thickness direction of the electrode assembly, a projection of the third insulator at least partially overlaps with a projection of the second insulating layer.

11. The electrochemical apparatus according to claim 10, wherein the first electrode plate further comprises a fourth insulator disposed opposite to the second tab, and the fourth insulator is disposed on a surface of the first active substance layer facing away from the first current collector; and in the thickness direction of the electrode assembly, the projection of the second insulating layer and the projection of the third insulator cover a projection of the fourth insulator.

12. The electrochemical apparatus according to claim 1, wherein the first insulating layer comprises an insulating material, and the insulating material comprises at least one of polytetrafluoroethylene, polyvinylidene fluoride, or non-metallic silicate.

13. The electrochemical apparatus according to claim 1, wherein a functional coating is provided between the first insulating layer and the second active substance layer.

14. An electronic apparatus, comprising a load and the electrochemical apparatus according to claim 1, wherein the electrochemical apparatus is configured to supply power to the load.

15. The electronic apparatus according to claim 14, wherein the second active substance layer comprises a first active region disposed on the surface of the second current collector and a second active region disposed on a surface of the first insulating layer, and the second active region is provided with a first insulator on a surface facing away from the first insulating layer.

16. The electronic apparatus according to claim 15, wherein in the thickness direction of the electrode assembly, a total thickness of the first insulating layer and the second active region is equal to a thickness of the first active region.

17. The electronic apparatus according to claim 14, wherein the second electrode plate further comprises a second recess, the second recess exposes a portion of the surface of the second current collector, the second electrode plate further comprises a second tab, and an end of the second tab is disposed in the second recess; and the second tab extends out of the second electrode plate in a first direction, and a direction perpendicular to both the first direction and the thickness direction of the electrode assembly is defined as a second direction; wherein
in the second direction, the second electrode plate is provided with a second insulating layer on two sides of the second recess, the second insulating layer is disposed on the surface of the second current collector, and the second insulating layer is connected to the second active substance layer in the second direction.

18. The electronic apparatus according to claim 17, wherein the second electrode plate further comprises a third insulator disposed on a surface of the second tab, and in the thickness direction of the electrode assembly, a projection of the third insulator at least partially overlaps with a projection of the second insulating layer.

19. The electrochemical apparatus according to claim 18, wherein the first electrode plate further comprises a fourth insulator disposed opposite the second tab, and the fourth insulator is disposed on a surface of the first active substance layer facing away from the first current collector; and in the thickness direction of the electrode assembly, the projection of the second insulating layer and the projection of the third insulator cover a projection of the fourth insulator.

20. The electronic apparatus according to claim 14, wherein the first insulating layer comprises an insulating material, and the insulating material comprises at least one of polytetrafluoroethylene, polyvinylidene fluoride, or non-metallic silicate.
